(19) United States
(12) Patent Application Publication
(10) Pub. No.: US 2026/0131689 A1
(43) Pub. Date: May 14, 2026

(54) NON-CONTACT POWER FEEDING SYSTEM, VEHICLE, AND NON-CONTACT POWER FEEDING POWER RECEIVING DEVICE

(71) Applicants: TOYOTA JIDOSHA KABUSHIKI KAISHA, Toyota-shi Aichi (JP); DENSO CORPORATION, Kariya-shi Aichi (JP)

(72) Inventors: Kazutaka KIMURA, Mishima-shi Shizuoka-ken (JP); Toshiya HASHIMOTO, Miyoshi-shi Aichi-ken (JP); Makoto HASHIMOTO, Seto-shi Aichi-ken (JP); Nobuhisa YAMAGUCHI, Aichi (JP); Masaki KANESAKI, Aichi (JP); Keisuke TANI, Aichi (JP); Kazuyoshi OBAYASHI, Aichi (JP); Yuichi TAKEMURA, Aichi (JP)

(73) Assignees: TOYOTA JIDOSHA KABUSHIKI KAISHA, Toyota-shi Aichi (JP); DENSO CORPORATION, Kariya-shi Aichi (JP)

(21) Appl. No.: 18/865,174

(22) PCT Filed: Apr. 3, 2023
(86) PCT No.: PCT/JP2023/013860

§ 371 Date: Nov. 12, 2024

(30) Foreign Application Priority Data
May 30, 2022 (JP) 2022-087816

(51) Int. Cl. B60L 53/66; B60L 53/12; G06Q 30/0283; G06Q 50/06; H02J 50/10; H02J 50/80

(52) U.S. Cl. CPC B60L 53/665; B60L 53/12; G06Q 30/0283; H02J 50/10; H02J 50/80; G06Q 50/06

(57) ABSTRACT

A non-contact power feeding system that supplies power in a non-contact manner from a power feeding device provided on a traveling path of a vehicle to the vehicle during traveling, the non-contact power feeding system including: a determination means for determining start and stop of power feeding from the power feeding device to the vehicle based on an energy balance of electrical equipment included in the vehicle; and a charging calculation means for calculating a power feeding amount and an amount of money to be charged to the vehicle based on a determination result of the determination means.

### CROSS-REFERENCE TO RELATED APPLICATIONS

This application is a U.S. National Phase application of PCT/JP2023/013860 filed Apr. 3, 2023, which claims priority to Japanese Patent Application No. 2022-087816 filed May 30, 2022, the entire contents of which are herein incorporated by reference.

### FIELD

The present disclosure relates to a non-contact power feeding system that supplies power in a non-contact manner to a vehicle during traveling, a vehicle, and a non-contact power feeding power receiving device.

### BACKGROUND

Patent Literature 1 describes a non-contact power feeding system that sets a predetermined amount of money to the amount of money to be collected as power transmission starts, and corrects the amount of money to be collected based on a difference between the predetermined amount of money and a rate corresponding to the amount of power actually transmitted or the amount of power actually received by a vehicle.

### CITATION LIST

### Patent Literature

Patent Literature 1: Japanese Laid-open Patent Publication No. 2014-79077

### SUMMARY

### Technical Problem

In order to configure the non-contact power feeding system described in Patent Literature 1, separate components such as a device for measuring the amount of power and a device for detecting the vehicle are required, and thus there is room for improvement.

The present disclosure has been made in view of the above problem, and an object thereof is to provide a non-contact power feeding system, a vehicle, and a non-contact power feeding power receiving device capable of calculating a power feeding amount and the amount of money to be charged to the vehicle without providing a separate component.

### Solution to Problem

A non-contact power feeding system according to the present disclosure that supplies power in a non-contact manner from a power feeding device provided on a traveling path of a vehicle to the vehicle during traveling, includes: a determination means for determining start and stop of power feeding from the power feeding device to the vehicle based on an energy balance of electrical equipment included in the vehicle; and a charging calculation means for calculating a power feeding amount and an amount of money to be charged to the vehicle based on a determination result of the determination means.

A vehicle according to the present disclosure capable of receiving power from a non-contact power feeding system that supplies power in a non-contact manner from a power feeding device provided on a traveling path of the vehicle to the vehicle during traveling, includes: a determination means for determining start and stop of power feeding from the power feeding device to the vehicle based on an energy balance of electrical equipment included in the vehicle; and a notification means for notifying a charging device of the non-contact power feeding system of a determination result of the determination means. Further, the charging device uses the determination result in a process of calculating a power feeding amount and an amount of money to be charged to the vehicle.

A non-contact power feeding power receiving device according to the present disclosure mounted on a vehicle capable of receiving power from a non-contact power feeding system that supplies power in a non-contact manner from a power feeding device provided on a traveling path of the vehicle to the vehicle during traveling, includes: a determination means for determining start and stop of power feeding from the power feeding device to the vehicle based on an energy balance of electrical equipment included in the vehicle; and a notification means for notifying a charging device of the non-contact power feeding system of a determination result of the determination means. Further, the charging device uses the determination result in a process of calculating a power feeding amount and an amount of money to be charged to the vehicle.

### Effects

Since the non-contact power feeding system, the vehicle, and the non-contact power feeding power receiving device according to the present disclosure determine the start and stop of power feeding from the power feeding device to the vehicle based on the energy balance of the electrical equipment included in the vehicle, it is possible to calculate the power feeding amount and the amount of money to be charged to the vehicle without providing a separate component.

### BRIEF DESCRIPTION OF DRAWINGS

FIG. 1 is a block diagram illustrating a configuration of a non-contact power feeding system according to an embodiment of the present disclosure.

FIG. 2 is a circuit diagram illustrating a configuration of a vehicle illustrated in FIG. 1.

FIG. 3 is a diagram illustrating an energy balance of the vehicle when power feeding is not performed.

FIG. 4 is a diagram illustrating an energy balance of the vehicle when power feeding is performed.

FIG. 5 is a diagram for explaining a modification of power feeding determination.

FIG. 6 is a diagram for explaining a modification of power feeding determination.

FIG. 7 is a diagram for explaining a calculation example of a power feeding rate.

FIG. 8 is a diagram for explaining a method of acquiring an electrical characteristic of the vehicle.

FIG. 9 is a diagram for explaining a method of acquiring the electrical characteristic of the vehicle.

FIG. 10 is a diagram for explaining a modification of power feeding determination.

FIG. 11 is a diagram for explaining a modification of power feeding determination.

FIG. 12 is a diagram for explaining a modification of power feeding determination.

FIG. 13 is a diagram for explaining an effect according to the modification of the power feeding determination illustrated in FIG. 12.

FIG. 14 is a diagram for explaining a modification of power feeding determination.

FIG. 15 is a diagram for explaining a modification of power feeding determination.

FIG. 16 is a diagram for explaining a modification of power feeding determination.

### DESCRIPTION OF EMBODIMENTS

Hereinafter, a non-contact power feeding system according to an embodiment of the present disclosure will be described in detail with reference to the drawings.

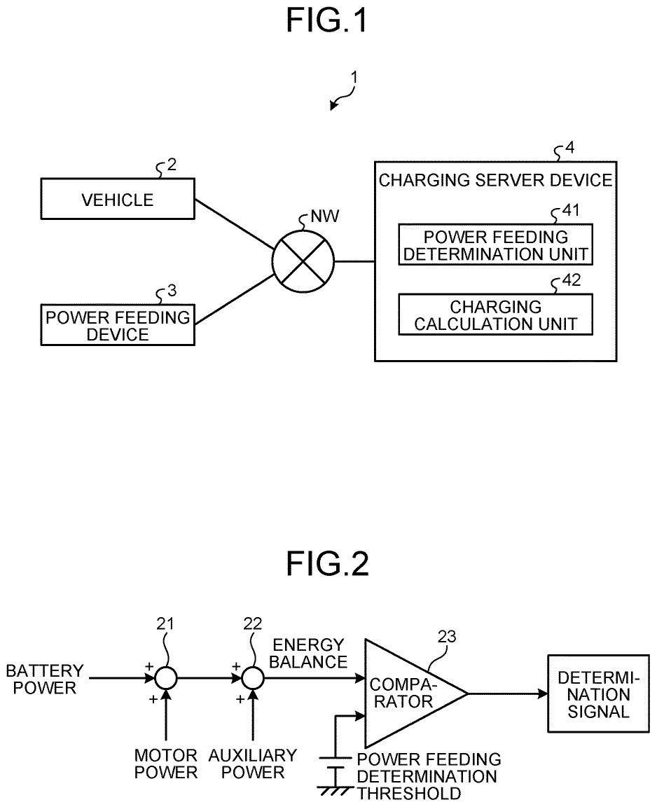

FIG. 1 is a block diagram illustrating a configuration of the non-contact power feeding system according to the embodiment of the present disclosure. As illustrated in FIG. 1, the non-contact power feeding system 1 according to the embodiment of the present disclosure is a system that supplies power in a non-contact manner to a vehicle during traveling, and includes a vehicle 2, a power feeding device 3, and a charging server device 4.

The vehicle 2 includes a known vehicle such as a hybrid vehicle (HV), an electric vehicle (EV), a plug-in hybrid vehicle (PHV), or a fuel cell electric vehicle (FCEV), and includes a communication module capable of performing information communication via an electric communication line NW such as an Internet line network or a mobile phone line network. In addition, as illustrated in FIG. 2, the vehicle 2 includes an adder 21 that calculates the sum of an input/output power amount (battery power) of a battery and an input/output power amount (motor power) of a motor, an adder 22 that calculates the sum of an output of the adder 21 and a power consumption amount (auxiliary power) of an auxiliary machine, and a comparator 23 that compares a magnitude relationship between an output (energy balance) of the adder 22 and a power feeding determination threshold and outputs a power feeding determination signal indicating that power feeding from the power feeding device 3 is performed when the output of the adder 22 is larger than the power feeding determination threshold. Regarding the motor power, instead of using a detection value, the motor power corresponding to an operation command for the motor may be read from a map, or a predicted regenerative power amount may be used. In addition, regarding the auxiliary power, instead of using a detection value, the auxiliary power may be read from the map according to on/off of the auxiliary power.

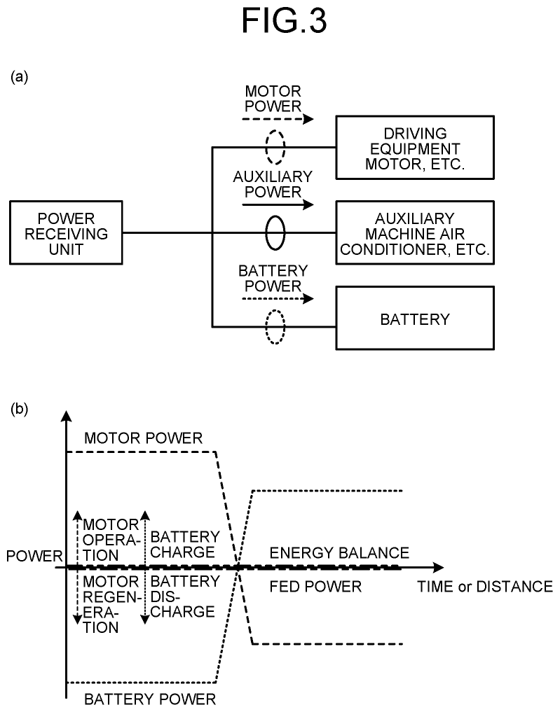

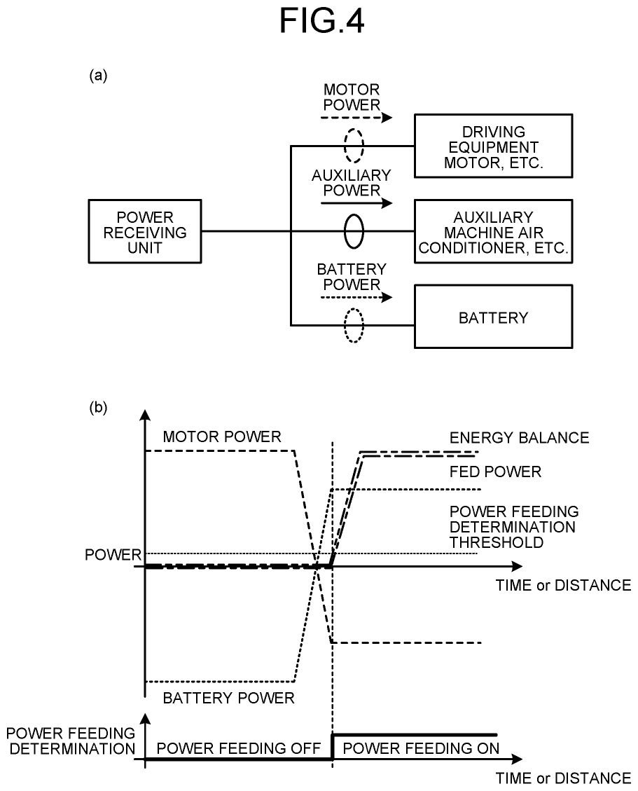

As illustrated in parts (a) and (b) of FIG. 3, the energy balance of electrical equipment included in the vehicle 2 is ±zero due to the power consumption by the electrical equipment such as the motor with respect to the power supply (discharge) from the battery. On the other hand, even when the regenerative power is returned from the motor, the battery is charged, and the energy balance of the vehicle 2 becomes zero. In part (b) of FIG. 3, illustration of the auxiliary power is omitted. On the other hand, as illustrated in parts (a) and (b) of FIG. 4, when power fed from the non-contact power feeding system 1 is received via a power receiving unit, the energy balance of the electrical equipment included in the vehicle 2 swings to the positive side. Therefore, the vehicle 2 compares the magnitude relationship between the output of the adder 22 and the power feeding determination threshold using the comparator 23, and when the output of the adder 22 is larger than the power feeding determination threshold, the vehicle 2 determines that the power feeding from the power feeding device 3 is performed, and outputs the power feeding determination signal. Then, the vehicle 2 transmits the power feeding determination signal, via the electric communication line NW, to the charging server device 4 together with unique identification information (vehicle ID) assigned to the vehicle 2. The vehicle 2 may transmit position information (GPS signal or the like) of the vehicle 2 together with the power feeding determination signal so that it is possible to calculate a distance (power feeding section) by which the vehicle 2 moves while the power feeding determination signal is on.

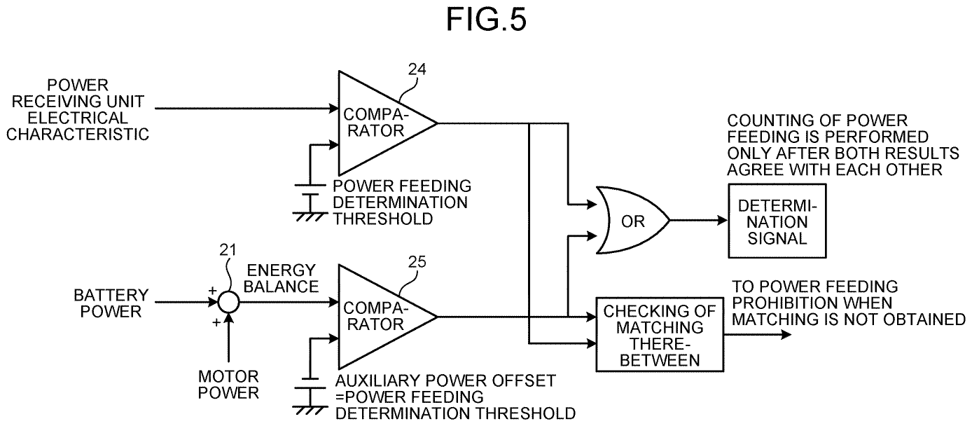

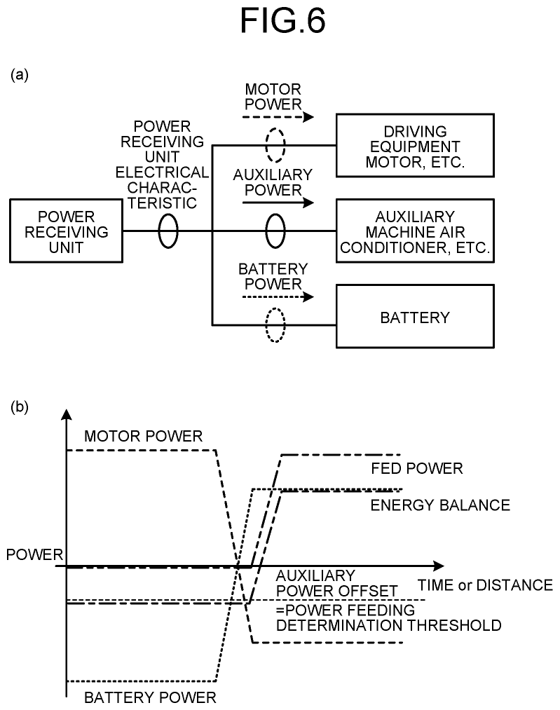

It is also possible to perform the power feeding determination only by the electrical characteristic (at least one of voltage, current, and power) of an output point (before power is sent to the motor, the battery, the auxiliary machine, or the like. See part (a) of FIG. 6) of the power receiving unit. However, in this case, by disconnecting electrical wiring to which a sensor that detects the electrical characteristic of the output point is connected and providing electrical wiring that bypasses the output point, there is a possibility that fraud is performed to make it appear that power feeding is not performed although power is actually fed. Therefore, in some embodiments, as illustrated in FIG. 5 and parts (a) and (b) of FIG. 6, a comparator 24 is provided that performs power feeding determination by comparing a magnitude relationship between the electrical characteristic of the power receiving unit and the power feeding determination threshold, and a comparator 25 that performs power feeding determination by comparing a magnitude relationship between the output (energy balance) of the adder 21 and the power feeding determination threshold (value obtained by offsetting the auxiliary power), and to output the power feeding determination signal when the power feeding determination result of the comparator 24 and the power feeding determination result of the comparator 25 match.

Returning to FIG. 1, the power feeding device 3 includes a rectifier that rectifies a DC voltage from a system, a plurality of inverters that convert the DC voltage rectified by the rectifier into an AC voltage, and a plurality of power transmitters that transmit the AC voltage output from the plurality of inverters to the vehicle 2 side.

The charging server device 4 includes an information processing device such as a workstation, and is connected to the vehicle 2 and the power feeding device 3 via the electric communication line NW. The charging server device 4 performs information communication with the vehicle 2 and the power feeding device 3 via the electric communication line NW. In addition, the charging server device 4 functions as a power feeding determination unit 41 and a charging calculation unit 42 when an arithmetic processing device such as a central processing unit (CPU) inside the information processing device executes a computer program.

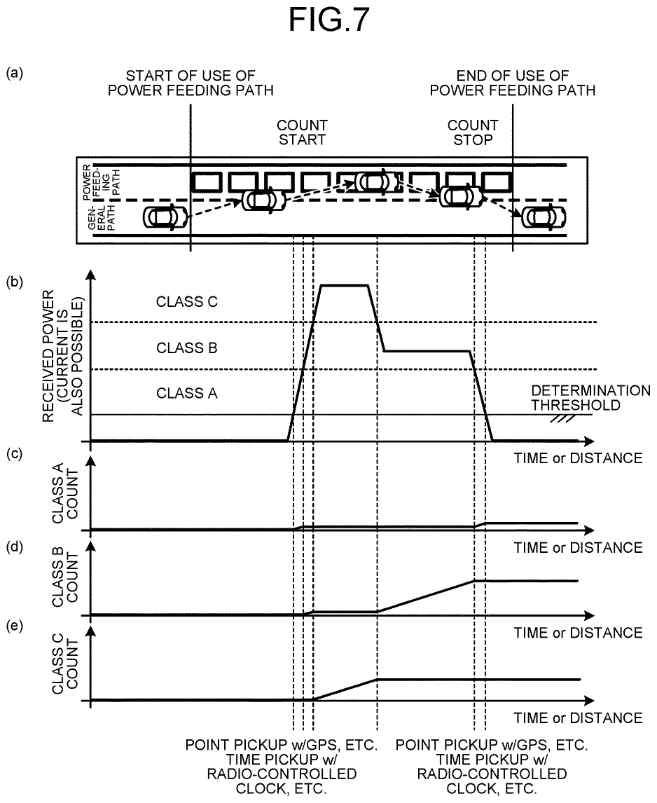

The power feeding determination unit 41 determines a time (power feeding time) and a section (power feeding section) in which a power feeding operation to the vehicle 2 is performed based on the power feeding determination signal and the vehicle ID transmitted from the vehicle 2, and outputs information on the determined power feeding time and power feeding section to the charging calculation unit 42 together with the vehicle ID. The charging calculation unit 42 calculates a power feeding amount to the vehicle 2 based on the power feeding time and the power feeding section output from the power feeding determination unit 41, and charges a power feeding rate (rate to be charged) to a user of the vehicle 2 corresponding to the vehicle ID according to the calculated power feeding amount. As illustrated in parts (a) to (e) of FIG. 7, a received power amount of the vehicle 2 may be classified in advance according to the magnitude of the received power amount, and the charging calculation unit 42 may calculate the power feeding rate according to the power feeding time or the power feeding section of each class.

As is clear from the above description, in the non-contact power feeding system 1 according to the embodiment of the present disclosure, the charging server device 4 determines the start and stop of power feeding from the power feeding device 3 to the vehicle 2 based on the energy balance of the electrical equipment included in the vehicle 2. Therefore, it is possible to calculate the power feeding amount and the amount of money to be charged to the vehicle 2 without providing a separate component.

In a case where the power feeding device feeds power in contact with the vehicle, a current (charging current) of an interface unit between the power feeding device and the vehicle may be detected as an electrical characteristic of the power receiving unit as illustrated in part (a) of FIG. 8. In addition, as illustrated in part (b) of FIG. 8, in a case where an element for backflow prevention such as a diode element or a switching element is disposed between the interface unit and the battery, a voltage (receiving end voltage) between the interface unit and the element may be detected as the electrical characteristic of the power receiving unit. Further, as illustrated in part (c) of FIG. 8, in a case where a rectifier for preventing a short circuit at the time of positive and negative reverse connection is disposed between the interface unit and the battery, an input voltage (receiving end voltage) of the rectifier may be acquired as the electrical characteristic of the power receiving unit. In addition, as illustrated in part (d) of FIG. 8, even when the output of the power feeding device is an AC output, the electrical characteristic can be detected at the same detection point. Further, even in a case where the power feeding device feeds power to the vehicle in a non-contact manner, the electrical characteristic can be detected at the same detection point as in a case where the power feeding device feeds power in contact with the vehicle.

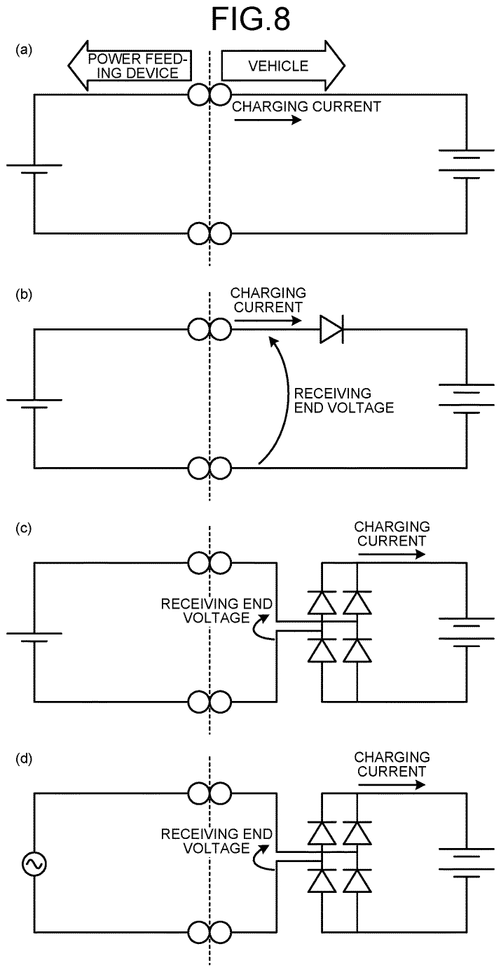

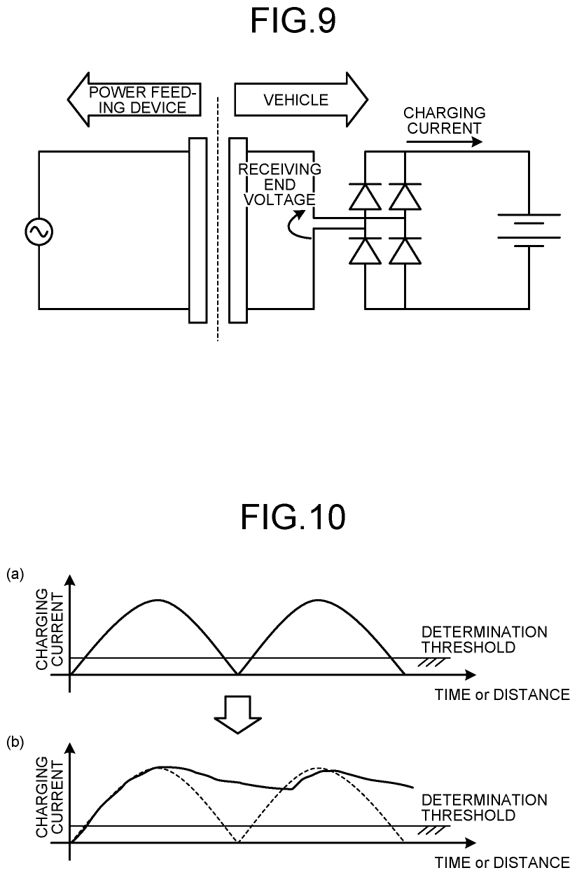

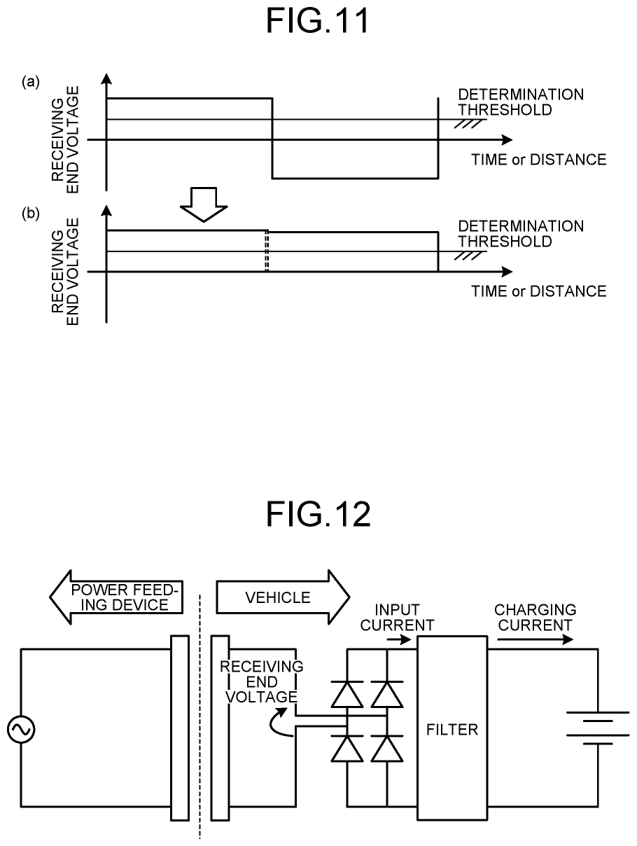

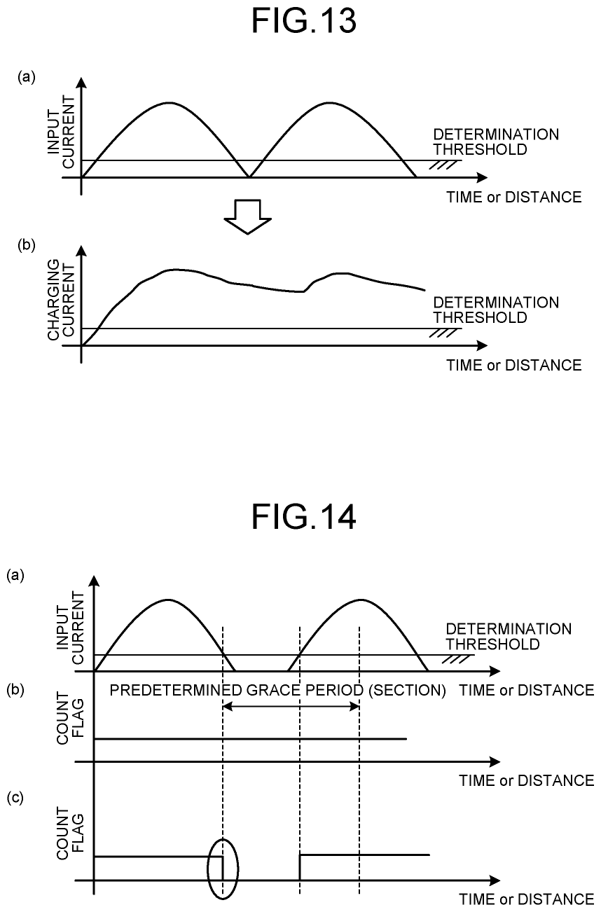

As illustrated in FIG. 9, in a case where the charging current on the output side of an AC unit is detected as the electrical characteristic of the power receiving unit, since the charging current has a half-wave waveform passing through a small current region as illustrated in part (a) of FIG. 10, an input current crosses the determination threshold every cycle, and the number of times of processing increases. Therefore, in some embodiments, as illustrated in part (b) of FIG. 10, peak hold processing is performed on the charging current and then compare the charging current with the power feeding determination threshold. In a case where the receiving end voltage is detected as the electrical characteristic of the power receiving unit, the peak hold processing may be performed after rectifying the receiving end voltage as illustrated in parts (a) and (b) of FIG. 11. In addition, instead of performing the power feeding determination using the input current as it is, the input current may be input to a filter as illustrated in FIG. 12, and the power feeding determination may be performed using the smoothed input current (charging current) at the subsequent stage of the filter. As illustrated in part (a) of FIG. 13, since the input current has a half-wave waveform passing through the small current region, the input current crosses the power feeding determination threshold every cycle, and the number of times of processing increases. On the other hand, in a case where the smoothed charging current at the subsequent stage of the filter is used, since the number of times of crossing the power feeding determination threshold decreases as illustrated in part (b) of FIG. 13, it is possible to suppress an increase in the number of times of processing.

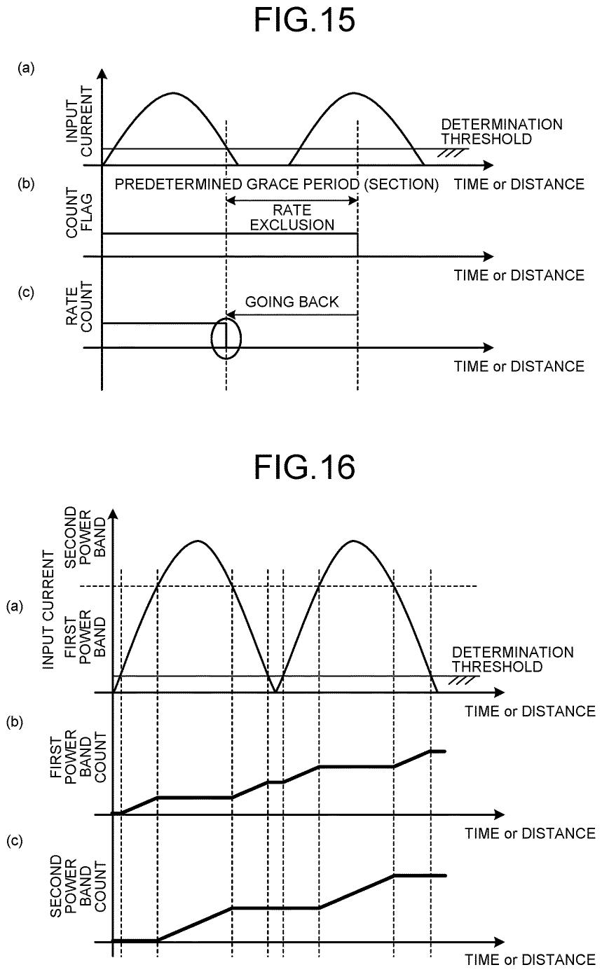

As illustrated in parts (a) and (c) of FIG. 14, when the counting of power feeding is stopped at the timing when the power feeding determination signal is no longer output from the vehicle 2, fine rate calculation increases, and there is a possibility that calculation data increases unnecessarily, leading to memory tightness. Therefore, as illustrated in part (b) of FIG. 14, in a case where the power feeding determination signal is output from the vehicle 2 within a predetermined grace period (grace section) after the power feeding determination signal is not output from the vehicle 2, the counting of the power feeding time and the power feeding section may be continued. In addition, in this case, as illustrated in parts (a) to (c) in FIG. 15, in a case where it is recognized that the output of the power feeding determination signal is stopped beyond the grace period, the power feeding rate may be calculated by going back to the time when the output of the power feeding determination signal is actually stopped. In addition, a charging opportunity loss time during the grace period may be separately counted, and a rate corresponding to the charging opportunity loss time may be subtracted at the time of calculating the power feeding rate. In addition, the unit price of the power feeding rate of the non-contact power feeding system 1 may be determined in consideration of the charging opportunity loss time. In addition, as illustrated in parts (a) and (b) of FIG. 16, the unit price of the power feeding rate of the non-contact power feeding system 1 may be determined according to a receiving power band, and the power feeding rate of the non-contact power feeding system 1 may be calculated in consideration of how many counts are made in each receiving power band. For example, in the examples illustrated in parts (a) and (b) in FIG. 16, the power feeding rate of the non-contact power feeding system 1 can be calculated as (count value of first power band×unit price of first power band power feeding rate)+(count value of second power band×unit price of second power band power feeding rate)+α.

Although the embodiment to which the present disclosure made by the present inventors is applied has been described above, the present disclosure is not limited by the description and drawings constituting a part of the disclosure of the present disclosure according to the present embodiment. That is, other embodiments, examples, operation techniques, and the like made by those skilled in the art based on the present embodiment are all included in the scope of the present disclosure.

### Industrial Applicability

According to the present disclosure, it is possible to provide a non-contact power feeding system, a vehicle, and a non-contact power feeding power receiving device capable of calculating a power feeding amount and the amount of money to be charged to the vehicle without providing a separate component.

### Reference Signs List

1 NON-CONTACT POWER FEEDING SYSTEM
2 VEHICLE
3 POWER FEEDING DEVICE
4 CHARGING SERVER DEVICE
21, 22 ADDER
23, 24, 25 COMPARATOR
41 POWER FEEDING DETERMINATION UNIT
42 CHARGING CALCULATION UNIT

1. A non-contact power feeding system that supplies power in a non-contact manner from a power feeding device provided on a traveling path of a vehicle to the vehicle during traveling, the non-contact power feeding system comprising:
a determination means for determining start and stop of power feeding from the power feeding device to the vehicle based on an energy balance of electrical equipment included in the vehicle; and
a charging calculation means for calculating a power feeding amount and an amount of money to be charged to the vehicle based on a determination result of the determination means.

2. A vehicle capable of receiving power from a non-contact power feeding system that supplies power in a non-contact manner from a power feeding device provided on a traveling path of the vehicle to the vehicle during traveling, the vehicle comprising:
a determination means for determining start and stop of power feeding from the power feeding device to the vehicle based on an energy balance of electrical equipment included in the vehicle; and
a notification means for notifying a charging device of the non-contact power feeding system of a determination result of the determination means, wherein
the charging device uses the determination result in a process of calculating a power feeding amount and an amount of money to be charged to the vehicle.

3. A non-contact power feeding power receiving device mounted on a vehicle capable of receiving power from a non-contact power feeding system that supplies power in a non-contact manner from a power feeding device provided on a traveling path of the vehicle to the vehicle during traveling, the non-contact power feeding power receiving device comprising:
a determination means for determining start and stop of power feeding from the power feeding device to the vehicle based on an energy balance of electrical equipment included in the vehicle; and
a notification means for notifying a charging device of the non-contact power feeding system of a determination result of the determination means, wherein
the charging device uses the determination result in a process of calculating a power feeding amount and an amount of money to be charged to the vehicle.

4. The non-contact power feeding system according to claim 1, wherein the determination means and the charging calculation means are a central processing unit.

5. The vehicle according to claim 2, wherein the determination means is a central processing unit.

6. The vehicle according to claim 5, wherein the notification means is a comparator.

7. The non-contact power feeding power receiving device according to claim 3, wherein the determination means is a central processing unit.

8. The non-contact power feeding power receiving device according to 7, wherein the notification means is a comparator.
